(19) United States
(12) Patent Application Publication
(10) Pub. No.: US 2015/0136826 A1
(43) Pub. Date: May 21, 2015

(54) COMBUSTION DRIVEN FASTENER SETTING DEVICE

(71) Applicants: Orlaw Massler, Triesenberg (LI); Josef Fünfer, Konigsbrunn (DE)

(72) Inventors: Orlaw Massler, Triesenberg (LI); Josef Fünfer, Konigsbrunn (DE)

(73) Assignee: HILTI AKTIENGESELLSCHAFT, Schaan (LI)

(21) Appl. No.: 14/402,740

(22) PCT Filed: May 29, 2012
(86) PCT No.: PCT/EP2012/059995

§ 371 Date: Nov. 21, 2014

(51) Int. Cl. B25C 1/08

(52) U.S. Cl. CPC B25C 1/08
USPC 227/10

(57) ABSTRACT

A fastener setting device for setting fastening elements has a combustion chamber for burning a fuel to produce combustion gases, and includes driving piston guided on an inner surface of a tubular piston guide. The driving piston is driven by the combustion gases in the combustion chamber and in the piston guide. The piston guide is formed from a metal strip curved to form a tube, the two facing longitudinal edges of which are connected by a seam and/or positively interlocking portions.

### FIELD OF THE INVENTION

The present invention pertains to a combustion driven fastener setting device as known, for example, from DE 10 2008 000 909 A1.

A nail or similar fastening means can be driven by the fastener setting device into a substrate. The energy required for this purpose is generated by burning a fuel in a combustion chamber. A driving piston converts the energy released in the combustion into a movement and it strikes a nail with a tappet. The driving piston is mounted in a piston guide into which the hot combustion gases from the combustion chamber can escape. The pressure-tight piston guide ensures that the excess pressure of the combustion gases can be dissipated only with propulsion of the driving piston. The piston guide and the driving piston have to be manufactured with accurate fit in order to ensure the pressure-tight closure. Both the piston guide and the piston are therefore manufactured from a solid body, which is trimmed by machining processes to the desired inner diameter and outer diameter. The surfaces have to undergo a subsequent treatment to achieve a high quality, and also to remove burrs produced by drilling.

### DISCLOSURE OF THE INVENTION

The fastener setting device according to the invention for setting fastening elements has a combustion chamber for burning a fuel to produce combustion gases. A driving piston is guided on an inner surface of a tubular piston guide. The driving piston is driven by the combustion gases in the combustion chamber and the piston guide. The piston guide is formed from a metal strip that has been curved to form a tube, the two facing longitudinal edges of which are connected by a seam and/or by positive interlocking portions. Limited but still sufficient dimensional accuracy and dimensional stability can be achieved by means of a metal strip.

The manufacturing method according to the invention makes it possible to introduce a ventilation opening in the piston guide without elaborate reworking steps, such as honing, deburring, etc. The manufacturing method provides for producing holes in a metal strip, cold forming the metal strip into a piston guide and connecting longitudinal edges of the metal strip to one another by a seam by integral bonding and/or by connecting said edges by interlocking with positive connection. Subsequently, a driving piston is inserted into the piston guide. The method according to the invention represents a turning away from the preconception that the piston guide would have to be produced by machining from a solid body.

An embodiment provides for the ventilation openings to be punched through an end of the piston guide that is remote from the combustion chamber. The punch foot is on the inner surface of the piston guide. The punching starting from the future inner surface ensures a burr-free inner surface. Although the inner surface is slightly deformed due to the vaulted conical punch foot, it requires no reworking, in particular no deburring.

The inner surface in terms of its shape is adapted to the outer contour of the piston, so that the latter is guided cleanly and provides a pressure-tight closure. A slight deviation due to indentations is found to be advantageous with regard to friction, without affecting the guiding and in particular the pressure-tight closure that is essential for the concept of driving by means of the combustion gases. An embodiment provides for the indentations to have a depth between 10 μm and 100 μm. Less deep indentations show no influence; it is assumed that the lubricant film compensates for these indentations. Deeper indentations increase the abrasion of the sealing elements and thus reduce the lifespan. A dimension of the indentation parallel to the work axis is preferably less than 200 μm. The indentations occupy a surface proportion between 1% and 10% of the inner surface.

An inner surface of the guide tube can be provided with multiple grooves extending transversely to the work axis and/or circular, square or rhombic dents. The grooves have a length that is greater than the width by at least one order of magnitude. The dents are approximately as long as they are broad.

The grooves extending transversely reduce the friction force without, as feared at first, considerably worsening the sealing of the pneumatic chamber for the air spring. Overall, it was possible to increase the efficiency of the striking mechanism, i.e., it was possible to increase the ratio of the striking energy delivered by the striker onto the tool to the energy supplied by the motor via the exciter.

An embodiment provides for the grooves to mutually intersect in a rhombus forming manner. One group of grooves has a different direction of revolution around the work axis from that of the grooves of another group.

An inclination angle of the grooves with respect to the work axis is preferably in the range between 30 degrees and 50 degrees. This applies particularly if the inclination of the grooves over their entire length is constant. In an embodiment, it is provided that the inclination angle decreases along a striking direction. The inclination angle in the area of the striking point is 20 degrees to 40 degrees.

### BRIEF DESCRIPTION OF THE FIGURES

The following description explains the invention in reference to embodiment examples and figures. The figures show:

FIG. 1, a fastener setting device;

FIG. 2, a piston guide;

FIG. 3, an unrolled inner surface of the piston guide;

FIG. 4, a cross section through the piston guide;

FIG. 5, an unrolled inner surface of the piston guide;

FIG. 6, a cross section through the piston guide.

Identical or functionally equivalent elements are indicated using identical reference numerals in the figures unless otherwise indicated.

### EMBODIMENTS OF THE INVENTION

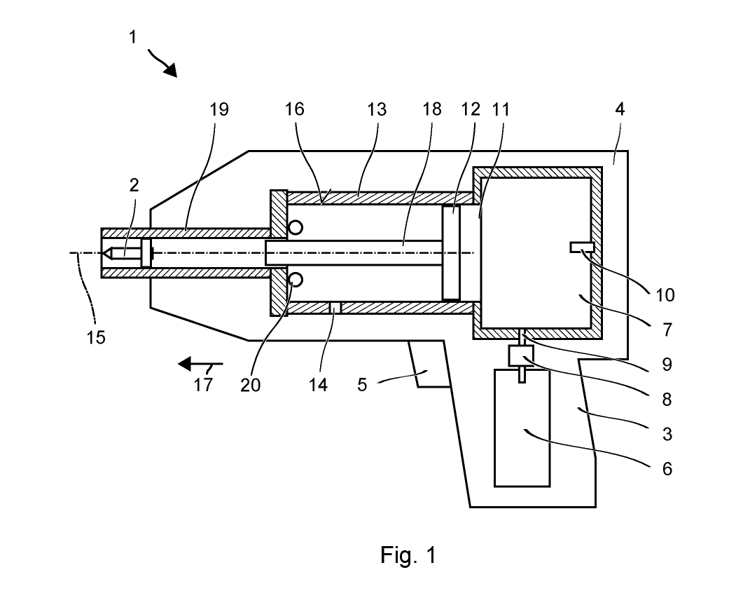

FIG. 1 shows an example of a fastener setting device 1 for nails 2, which is operated by means of a combustible fuel. The fuel is preferably a gas or a highly volatile liquid fuel.

The fastener setting device 1 has a handle 3 by means of which the user can guide the fastener setting device and hold it during the setting of the nails 2. The handle 3 is connected undetachably, rigidly or by means of damping elements to a housing 4 of the fastener setting device 1. On or near the handle 3, a trigger switch 5 is located, which, at the time of the actuation by the user, triggers a setting procedure. In addition to the actuation of the trigger switch 5, it is preferable also to release a safety mechanism, for example, by pressing the fastener setting device against a wall.

A cartridge 6 with the fuel can be inserted into the housing 4. For refilling with fuel, the cartridge 6 can be exchanged or refilled.

A portion of the fuel can be fed into a combustion chamber 7. This occurs preferably in response to an actuation of the trigger switch 5. For example, a valve 8 opens a feed line 9 between the cartridge 6 and the combustion chamber 7 for a predefined duration. Alternatively or additionally, the valve 8 measures a flow rate through the feed line 9 and closes after a predefined amount has flowed into the combustion chamber 7.

The combustion chamber 7 is provided with a spark plug 10 or a similar ignition device, in order to ignite the gas that has flowed into the combustion chamber 7 or gases of the fuel that have volatilized in the combustion chamber 7. The combustion chamber 7 has a single outlet 11 through which the combustion gases can flow out.

Instead of a gaseous or liquid fuel, it is also possible to use a powder fuel. The powder is distributed preferably in cartridges that can be inserted into the combustion chamber 7. The ignition device is designed for igniting the cartridges. At the time of the explosion of the powder, combustion gases that propel the driving piston 12 are also generated.

A piston guide 13 and a driving piston 12 arranged in the piston guide 13 close the outlet 11. The piston guide 13 is a substantially cylindrical tube that adjoins the combustion chamber 7. A diameter of the piston guide 13 is equal to or greater than the outlet 11. The combustion gases can flow only into the piston guide 13 from the combustion chamber 7. The piston guide 13 is peripherally closed. A ventilation opening 14 is provided at one end of the piston guide 13 that is remote from the combustion chamber 7. It is only through this ventilation opening 14 that is provided that the combustion gases can flow out.

The driving piston 12 is inserted into the piston guide 13. The driving piston 12 is movably mounted in the piston guide 13 along work axis 15 predetermined by the piston guide 13. The, for example, cylindrical driving piston 12 is adapted with accurate fit to the inner cross section of the piston guide 13. The driving piston 12 is in contact with its entire circumference with an inner wall 16 of the piston guide 13. A sealing ring can encompass the circumference of the driving piston 12, in order to compensate for manufacturing tolerances. The driving piston 12 closes the hollow space defined by the piston guide 13 and the combustion chamber 7. Since the combustion gases cannot escape through the combustion chamber 7 or through the piston guide 13, the combustion gases push the driving piston 12 along the work axis 15 in a driving direction 17 pointing away from the combustion chamber 7. The driving piston 12 is accelerated and it reaches a predefined kinetic energy preferably with low losses.

The driving piston 12 is provided with a rigidly connected tappet 18. The rod-shaped tappet 18 protrudes into a nail holder 19. The nail holder 19 is tubular, for example. A user places a nail in the nail holder 19, or an automatic or semiautomatic feed device places a nail in the nail holder 19. The tappet 18 accelerated by the driving piston 12 strikes the nail and moves said nail in the driving direction 17, for example, into a workpiece.

The movement of the driving piston 12 and of the tappet 18 in the driving direction 17 is stopped by an abutment 20. As it reaches the abutment 20, the driving piston 12 moves over the ventilation opening 14. The combustion gases can then escape.

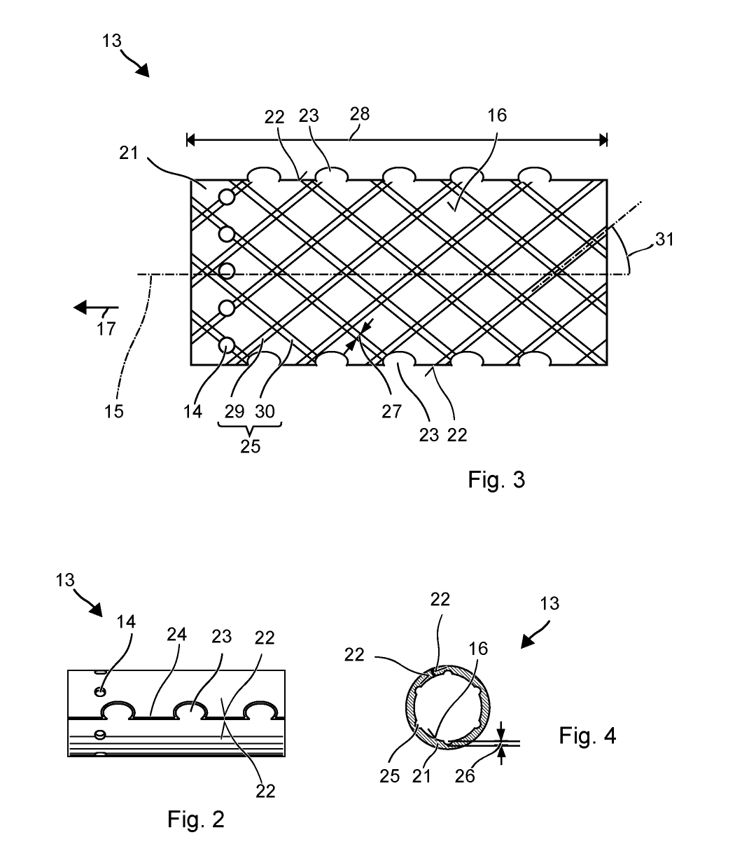

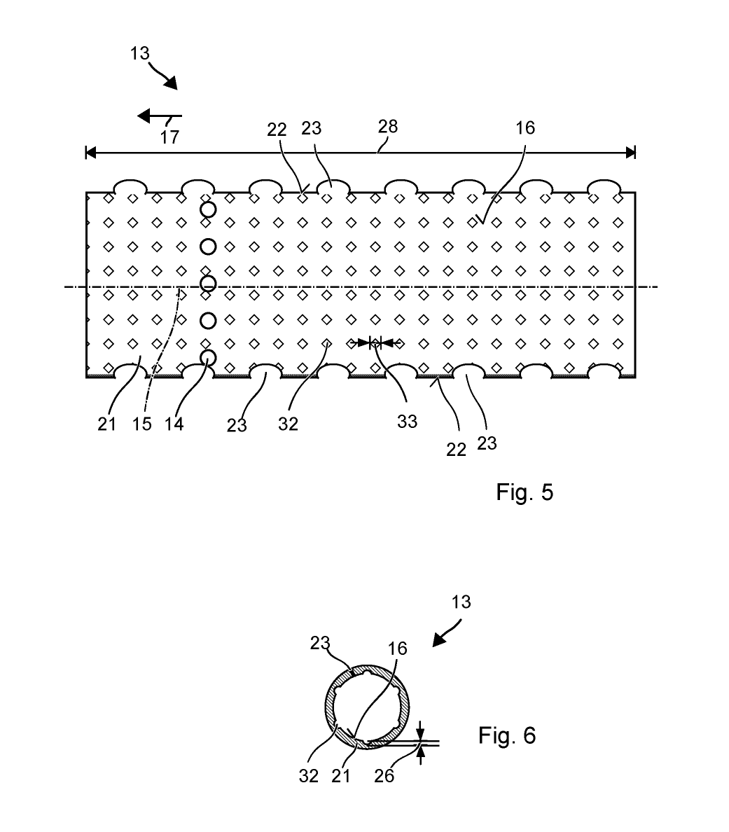

The piston guide 13 is produced from a curved metal strip 21 that is closed by a seam and/or an interlocked closure along the work axis 15 (FIG. 2). The facing edges 22 of the metal strip 21 can be provided with interlocking portions that engage with one another in the metal strip 21 curved to form the piston guide 13. The interlocking portions 23 can, in addition, be closed in an airtight manner by a welding seam. Alternatively, the interlocking portions 23 can be sealed in an airtight manner with a plastic. The metal strip 21 is represented unrolled in FIG. 3. FIG. 4 shows the piston guide 13 in a cross section.

A manufacturing method as an example for the piston guide 13 starts with a continuous band. The continuous band preferably has a width that is approximately 0.5% to 2% smaller than a circumference of the piston guide 13 to be produced. A punch punches the ventilation openings 14 into the continuous band. The punch preferably pushes from the future inner surface 16 outward, so that the punch entry forms on the inner surface 16. The punch entry is an approximately funnel-shaped indentation in the material of the continuous band, which is formed as the stamp is pushed through. Several rolls roll the continuous band in several steps to form a continuous tube. The side with the punch entry here ends up being on the inner surface of the tube. The edges 22 of the continuous band, which face one another after forming, are welded to one another. The welding can occur by induction, for example. A corresponding welding probe can be held in the area in which the two edges 22 start to contact one another. Due to the welding, a seam 24 forms, which connects the two edges in an integral bonding and airtight manner to one another.

A punch can provide the edges 22 with the interlocking portions 23. The interlocking portions 23 of the two edges 22 engage with one another during the rolling of the continuous band. The interlocking portions 23 can be produced with highly accurate fit, in order to achieve a sufficient pressure-tight closure for the piston guide 13. The interlocking portions 23 can be used alternatively or additionally to the welding seam 24. In additional embodiments, the interlocking portions 23 can be closed on the outer side by a silicone composition or another sealant.

The tube for the piston guide 13 is cut to length from the continuous tube produced. The piston guide 13 is shifted one or more times over a calibration cylinder or calibration cone and in the process is broadened to the desired circumference. The circumference of the calibration cylinder is preferably perfectly circular and slightly larger than the inner circumference of the continuous tube. The piston guide 13 is welded at one end to the combustion chamber 7. The driving piston 12 is inserted into the piston guide 13.

An additional manufacturing method starts with a continuous band, the width of which corresponds, for example, approximately to the length of the piston guide. The ventilation openings and optionally interlocking portions 23 are punched. A metal strip 21 is detached and wound to form the piston guide 13. The metal strip 21 can be rectangular or rhombic. The edges 22 are welded to one another and/or connected in a pressure-tight manner to one another by the interlocking portions 23.

The friction losses of the driving piston 12 on the inner surface 16 of the piston guide 13 should be as small as possible. A first reduction of the friction is achieved by means of a lubricant film. In addition, a structured inner surface 16 is found to be advantageous in comparison to a completely smooth inner surface. The inner surface 16 is provided with grooves 25 extending transversely to the work axis 15. FIG. 3 shows the unrolled inner surface 16 of the piston guide 13.

The grooves 25 have a depth 26 of more than 10 μm (micrometer) and a depth 26 of less than 100 μm. A width 27 of the grooves 25 is located in the range of the depth 26. For example, the grooves 25 are approximately one to five times as broad as they are deep. The depth 26 is the dimension of the groove 25 in radial direction; the width 27 is the smallest dimension of the groove 25 on the inner surface 16, and the length is the largest dimension on the inner surface 16. The grooves 25 can extend over the entire length 28 of the piston guide 13.

The grooves 25 extend in a helical spiral shape along the inner surface 16. An inclination of the grooves 25 with respect to the work axis 15 preferably remains constant over their length. A first group 29 of the grooves 25 extends in a positive direction of rotation and a second group 30 of the groves 25 extends in a negative direction of rotation. The grooves 25 of the two groups 29, 30 mutually intersect.

Adjacent grooves 25, of a group 29, 30, are in a mutual staggered arrangement at a spacing between 5000 μm to 20,000 μm along the work axis 15. The inner surface 16 between the adjacent grooves 25 is preferably smooth. Smooth means that the roughness of the inner surface 16 between the grooves 25 is at least one order of magnitude smaller than the depth 26 of the grooves 25.

A value of the inclination angle 31 of the grooves 25 with respect to the work axis 15 is in the range between 30 degrees and 50 degrees. The connection of the inclination in the interaction with the driving piston 12, the sealing ring, the lubricant film and the periodically changing temperature and pressure ratios is not completely understood. However, both smaller and also larger inclination angles 31 outside the range result in greater losses of the fastener setting device 1. The inclination angle 31 of the helical grooves 25 is the difference between the pitch angle and 90 degrees.

The grooves 25 are preferably rolled into the metal strip 21 or they are introduced using another method that does not use machining The inner surface 16 thus remains free of burrs.

An additional embodiment provides for a variation of the inclination angle 31 along the work axis 15. The inclination angle 31 with respect to the work axis 15 increases in the driving direction 17. Close to the rear reversal point, the piston guide 13 has to be sealed against the high air pressure in the combustion chamber 7. For this purpose, grooves 25 that are, to the extent possible, perpendicular to the work axis 15 are preferable. However, this orientation of the grooves 25 generates greater friction resistance than grooves 25 parallel to the work axis 15. The inclination angle 31 close to the combustion chamber 7 is between 40 degrees and 60 degrees and it decreases in the direction toward the abutment 20 to between 20 degrees and 30 degrees.

An embodiment has point-shaped dents 32 instead of or in addition to the grooves 25 (FIG. 5). The dents 32 have a depth 26 between 10 μm and 100 μm. A diameter 33 of the dents 32 is approximately in the range of their depth 26. The dents 32 are preferably in a regular arrangement, for example, on nodal points of a grid with rectangular or rhombic cells. The entire surface area of the dents 32 is clearly smaller than the inner surface 16, for example, less than 10%. The remaining inner surface 16 is preferably smooth, i.e., it has a roughness of clearly less than 10 μm. The driving piston 12 is guided by the smooth inner surface 16.

The dents 32 can be stamped into the inner surface 16, for example, with a stamp. The buckling during the stamping can be smoothed out by a subsequent rolling or punching.

1. A combustion driven fastener setting device for driving fastening elements into a workpiece, comprising a combustion chamber for burning a fuel to produce combustion gases; a driving piston; a tubular piston guide having an inner surface on which the driving piston is guided, wherein the driving piston is driven by the combustion gases in the combustion chamber and in the piston guide, and wherein
the piston guide comprises a metal strip curved to form a tube, the metal strip having two facing longitudinal edges connected by a seam and/or by positively interlocking portions.

2. The combustion driven fastener setting device according to claim 1, comprising ventilation openings punched through an end of the piston guide remote from the combustion chamber, wherein a punch foot is on the inner surface of the piston guide.

3. The combustion driven fastener setting device according to claim 1, wherein the inner surface has a plurality of indentations formed in it.

4. The combustion driven fastener setting device according to claim 3, wherein the indentations have a depth between 10 μm and 100 μm.

5. The combustion driven fastener setting device according to claim 3, having a work axis, wherein a dimension of the indentation parallel to the work axis is less than 200 μm.

6. The combustion driven fastener setting device according to claim 3, wherein the indentations occupy a surface proportion between 1% and 10% of the inner surface.

7. The combustion driven fastener setting device according to claim 3, wherein the indentations include square, rhombic, or circular dents, the dents having respective lengths and widths which are substantially identical.

8. The combustion driven fastener setting device according to claim 3, having a work axis, wherein the inner surface of the piston guide has multiple grooves extending transversely to the work axis.

9. The combustion driven fastener setting device according to claim 8, wherein the grooves intersect in a rhombus forming manner.

10. The combustion driven fastener setting device according to claim 8, wherein an inclination angle of the grooves with respect to the work axis is between 30 degrees and 50 degrees.

11. The combustion driven fastener setting device according to claim 8, wherein an inclination angle of the grooves decreases along a driving direction.

12. The combustion driven fastener setting device according to claim 2, wherein the inner surface has a plurality of indentations formed in it.

13. The combustion driven fastener setting device according to claim 12, wherein the indentations have a depth between 10 μm and 100 μm.

14. The combustion driven fastener setting device according to claim 4, having a work axis, wherein a dimension of the indentation parallel to the work axis is less than 200 μm.

15. The combustion driven fastener setting device according to claim 13, having a work axis, wherein a dimension of the indentation parallel to the work axis is less than 200 μm.

16. The combustion driven fastener setting device according to claim 4, wherein the indentations occupy a surface proportion between 1% and 10% of the inner surface.

17. The combustion driven fastener setting device according to claim 5, wherein the indentations occupy a surface proportion between 1% and 10% of the inner surface.

18. The combustion driven fastener setting device according to claim 13, wherein the indentations occupy a surface proportion between 1% and 10% of the inner surface.

19. The combustion driven fastener setting device according to claim 14, wherein the indentations occupy a surface proportion between 1% and 10% of the inner surface.

20. The combustion driven fastener setting device according to claim 4, wherein the indentations include square, rhombic, or circular dents, the dents having respective lengths and widths which are substantially identical.
